(19) United States
(12) Patent Application Publication
(10) Pub. No.: US 2020/0379624 A1
(43) Pub. Date: Dec. 3, 2020

(54) ELECTRONIC DEVICE

(71) Applicant: CANON KABUSHIKI KAISHA, Tokyo (JP)

(72) Inventor: Hirokazu Izuoka, Kawasaki-shi (JP)

(21) Appl. No.: 16/889,413

(22) Filed: Jun. 1, 2020

(30) Foreign Application Priority Data
Jun. 3, 2019 (JP) 2019-103709

(51) Int. Cl. G06F 3/041; H04N 5/232; G06F 3/044

(52) U.S. Cl. CPC G06F 3/04186; G06F 3/044; H04N 5/23216; H04N 5/232933

(57) ABSTRACT

An electronic device includes: a touch detector configured to detect a touch; and a control unit configured to, in a case where a touch is not released and an increase in a touch area from a first time point to a second time point is greater than a predetermined increase, after the second time point, not control so that a function corresponding to a movement of a touch position is executed when a difference between the touch position at the first time point and a corrected position obtained by correcting a current touch position toward the touch position at the first time point is less than a threshold value, and control so that the function corresponding to the movement of the touch position is executed when the difference is greater than the threshold value.

### BACKGROUND OF THE INVENTION

### Field of the Invention

The present invention relates to an electronic device capable of sensing a touch on an operation surface.

### Description of the Related Art

Finger-touch sensitive interfaces (touch sensors) provided for example in smartphones and portable music players have been widely available. As a touch sensor, there is a capacitive sensor which is sensitive to a touch without being pressed and used as a simple switch or to detect the operation of tracing the operation surface (sliding operation) by a finger. In order to allow a user to intuitively manipulate an electronic device, sliding operation is assigned with a function such as icon movement on the screen or changing the voltage for playing music.

When a capacitive sensor is used, the center position and the position of the center of gravity of the part (contact part) of the operation surface touched by the finger is determined as a touch position. Therefore, when the touch area (the area of the contact part) changes depending on how the finger presses the surface, the inclination of the finger or the size of the finger, the touch position may change contrary to the user's intention. In particular, when the user touches the touch sensor while grasping the electronic device or depending on the mounting position of the touch sensor, the touch position is more likely to change in an unintended way.

The conventional techniques in view of the foregoing are for example disclosed in Japanese Patent Application Publication No. 2008-191791 and Japanese Patent Application Publication No. 2010-204812. Japanese Patent Application Publication No. 2008-191791 discloses correction of a touch position so that the touch position moves in the direction of touch movement (the moving direction of the touch position) detected immediately before at the touch moving speed (the moving speed of the touch position) detected immediately before when the rate of increase in the touch area is equal to or greater than a threshold value. In the disclosure of Japanese Patent Application Publication No. 2010-204812, the touch position is corrected with a smaller correction value as the width of the contact part increases.

When a touch sensor is attached in a position assumed to be operated with a thumb, the user may unintentionally press the thumb against the touch sensor. In such a case, sliding operation may be erroneously detected even when the user only intends to touch (does not intend to do the sliding operation). In particular, when the movement of the touch position with a small amount of movement relative to the size (width) of the thumb is detected as sliding operation, the sliding operation is likely to be erroneously detected.

In the disclosure of Japanese Patent Application Publication No. 2008-191791, when a finger is pressed against a touch sensor, the touch area is increased and the touch position is corrected so that the touch position moves in the direction of the touch movement detected immediately before at the touch movement speed detected immediately before. Therefore, when the user only intends to touch, and the amount of movement of the touch position to the touch position after correction exceeds a threshold value (a threshold value for detecting sliding operation), the sliding operation is erroneously detected.

In the disclosure of Japanese Patent Application Publication No. 2010-204812, the touch position is not corrected for a period of time after the user touches the touch sensor because the touch area fluctuates. Therefore, when the user only intends to touch, and the amount of movement of the touch position to the touch position after correction exceeds a threshold value (a threshold value for detecting sliding operation), the sliding operation is erroneously detected.

### SUMMARY OF THE INVENTION

The present invention provides an electronic device which can accurately determine user operation intended to move a touch position.

An electronic device according to the present invention includes: a touch detector configured to detect a touch on an operation surface; and at least one memory and at least one processor which function as: a control unit configured to, in a first case where a touch is not released and an increase in a touch area from a first time point to a second time point is not more than a predetermined increase, after the second time point, not control so that a function corresponding to a movement of a touch position is executed when a difference between the touch position at the first time point and a current touch position is less than a threshold value, and control so that the function corresponding to the movement of the touch position is executed when the difference between the touch position at the first time point and the current touch position is greater than the threshold value, and in a second case where a touch is not released and the increase in the touch area from the first time point to the second time point is greater than the predetermined increase, after the second time point, not control so that the function corresponding to the movement of the touch position is executed when the difference between the touch position at the first time point and a corrected position obtained by correcting the current touch position toward the touch position at the first time point is less than the threshold value, and control so that the function corresponding to the movement of the touch position is executed when the difference between the touch position at the first time point and the corrected position is greater than the threshold value.

Further features of the present invention will become apparent from the following description of exemplary embodiments with reference to the attached drawings.

### BRIEF DESCRIPTION OF THE DRAWINGS

FIGS. 1A and 1B are views of the appearance of a camera according to an embodiment of the present invention;

FIG. 2 is a block diagram of a configuration of the camera according to the embodiment;

FIGS. 3A to 3C are views illustrating how a touch sensor according to the embodiment is operated;

FIG. 4 is a view showing a structure of the touch sensor according to the embodiment;

FIGS. 5A and 5B are views showing how the finger moves to operate the touch sensor according to the embodiment;

FIG. 6A is a part of a flowchart for illustrating touch operation processing according to the embodiment;

FIG. 6B is a flowchart for illustrating a part of the touch operation processing according to the embodiment;

FIG. 6C is a flowchart for illustrating a part of the touch operation processing according to the embodiment;

FIGS. 7A and 7B illustrate a method for calculating a touch area according to the embodiment;

FIG. 8 is a graph for illustrating the change of the touch position over time according to the embodiment;

FIGS. 9A to 9C are views for illustrating the movement of a finger in sliding operation according to a first modification of the embodiment;

FIGS. 10A and 10B illustrate the touch area in the sliding operation according to the first modification;

FIG. 11 is a graph for illustrating the change of the touch position over time according to the first modification;

FIG. 12 is a flowchart for illustrating touch operation processing according to the first modification;

FIGS. 13A to 13C are views for illustrating manners of touching a touch sensor according to a second modification of the embodiment; and

FIG. 14 is a flowchart for illustrating touch operation processing according to the second modification.

### DESCRIPTION OF THE EMBODIMENTS

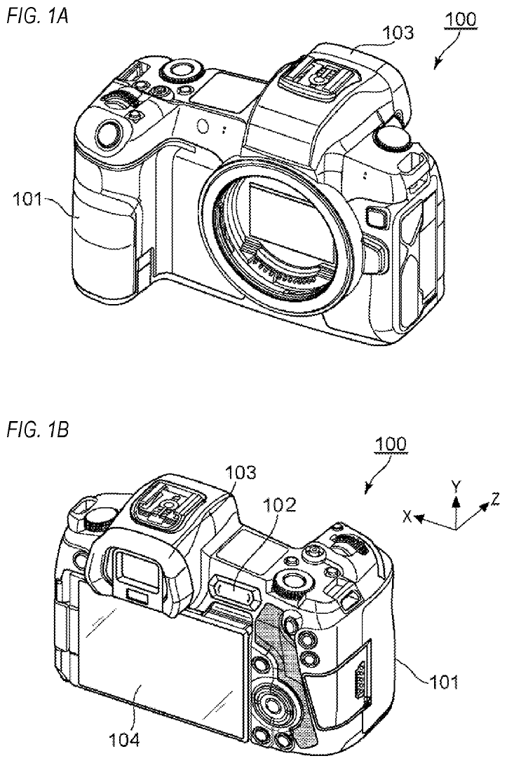

Hereinafter, a preferred embodiment of the present invention will be described with reference to the drawings. FIGS. 1A and 1B show the appearance of a digital camera (camera) 100 as an exemplary electronic device to which the present invention can be applied. FIG. 1A is a front perspective view of the camera 100, and FIG. 1B is a back perspective view of the camera 100. A lens unit (not shown) equipped with a replaceable imaging lens may be detachably mounted to the camera 100, and FIGS. 1A and 1B show the state in which the lens unit is not mounted.

A grip portion 101 has a shape which allows the user to easily grasp with the right hand when the user tries to aim the camera 100. For example, the user holds the grip portion 101 with the right hand to manipulate the camera 100 and supports the camera 100 with the left hand to manipulate the lens unit.

A touch sensor 102 is a touch operation member which senses a touch on the operation surface of the touch sensor 102. Although the shape of the touch sensor 102 is not particularly limited, the touch sensor 102 is a line-shaped touch control member (a touch bar or a line touch sensor) in FIGS. 1A and 1B in consideration of operability and design. The touch sensor 102 is positioned to allow the thumb of the right hand to operate (or touch) while the right hand holds the grip portion 90 in a normal gripping manner (in a manner recommended by the manufacturer).

A viewfinder 103 is an eyepiece (an eyepiece viewfinder or a look-in viewfinder) which the user looks into in order to check an object. The user may touch the touch sensor 102 while looking into the viewfinder 103 or keeping the eye apart from the viewfinder 103. The touch sensor 102 is disposed adjacent to and between the grip portion 101 (more specifically, a region obtained by projecting grip portion 101 on the rear side) and the viewfinder 103 and has a shape extending from the side of grip portion 101 to the side of viewfinder 103.

The display unit 104 displays various images and various kinds of information. For example, the display unit 104 displays a captured image, and when the shooting parameter is changed by user operation performed using the touch sensor 102, the display unit displays the state of change.

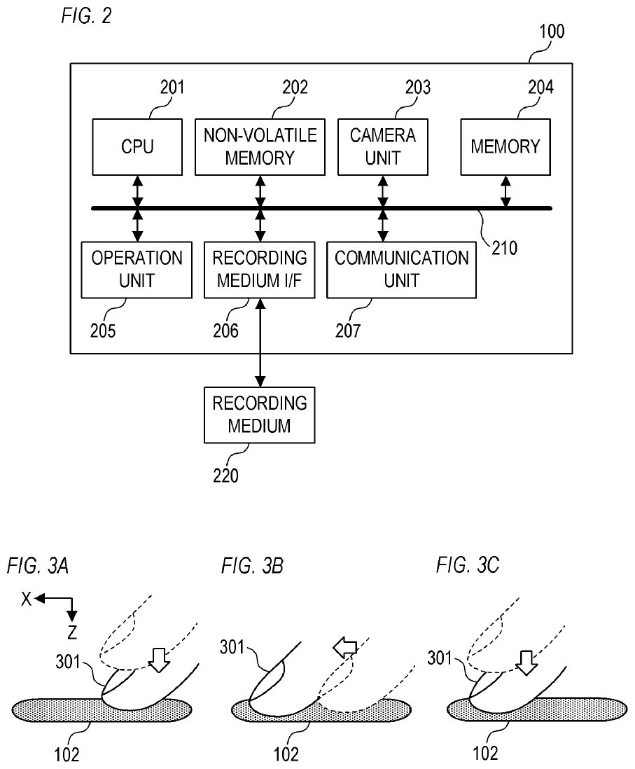

FIG. 2 is a block diagram of an exemplary configuration of the camera 100. The display unit 104, a CPU 201, a non-volatile memory 202, a memory 203, a camera unit 204, an operation unit 205, a recording medium I/F 206, and a communication unit 207 are connected to a bus 210. The components connected to the bus 210 may exchange data among one another through the bus 210.

The CPU 201 is a control unit which controls the entire camera 100. The non-volatile memory 202 is an electrically erasable/recordable memory such as an EEPROM. The non-volatile memory 202 records (stores) for example constants and programs for operating the CPU 201. Here, the programs refer to programs for executing various flowcharts which will be described in the following description of the embodiment. The CPU 201 executes programs recorded in the non-volatile memory 202 to realize various kinds of processing according to the embodiment, which will be described. The memory 203 is for example a RAM, and using the memory 203 as a working memory, the CPU 201 deploys constants and variables for operating the CPU 201 and programs read out from the non-volatile memory 202 in the memory 203.

The camera unit 204 is an imaging device including a CCD or a CMOS device which converts an optical image representing an object (light from the lens unit which is not shown) into an electrical signal. The operation unit 205 is an input unit which receives operation (user operation) from the user and is used to input various operation instructions to the CPU 201. The operation unit 205 includes for example a power supply switch, a shutter button, a setting button, and a menu button in addition to the touch sensor 102. The recording medium I/F 206 is an interface with a recording medium 220 such as a memory card and a hard disk. The recording medium 220 is a recording medium such as a memory card for recording (storing) captured images and includes for example a semiconductor memory or a magnetic disk. The communication unit 207 transmits/receives various images and various kinds of information to/from an external device connected wirelessly or by a wired cable. The communication unit 207 can also be connected to a wireless local area network (LAN) or the Internet. The communication unit 207 can also communicate with external devices by Bluetooth (registered trademark) or Bluetooth Low Energy.

The CPU 201 can detect the following operation on the touch sensor 102 or the state thereof
A new touch on the touch sensor 102 by a finger that has not touched the touch sensor 102, in other words, the start of touching (hereinafter referred to as Touch-Down).
The state in which the touch sensor 102 is kept touched with a finger (hereinafter referred to as “Touch-On”).
The state in which a finger moves on the touch sensor 102 while the finger touches the touch sensor 102 (hereinafter referred to as “Touch-Move”).
The state in which a finger which has touched the touch sensor 102 is (released) away from the touch sensor 102, in other words, the end of touching (hereinafter referred to as “Touch-Up”).
The state in which nothing touches the touch sensor 102 (hereinafter referred to as “Touch Off”).

When a Touch-Down is detected, a Touch-On is detected at the same time. After the Touch-Down, the Touch-On usually continues to be detected unless a Touch Up is detected. A Touch-On is detected at the same time when a Touch Move is detected. When a Touch-On is detected, a Touch Move is not detected unless the touch position is moved. After a Touch Up is detected for all the fingers or a pen which has touched, a Touch Off is attained.

These kinds of operation/states and the position coordinates at which the finger touches the touch sensor 102 are notified to the CPU 201 through the bus 210, and the CPU 201 determines which kind of operation (touch operation) has been performed on the touch sensor 102 on the basis of the notified information. Upon detecting the movement of the touch position for more than a predetermined distance (moving more than a predetermined amount), it is determined that sliding operation has been performed. When a finger touches the touch sensor 102 and the finger is released within a predetermined time period without sliding operation, it is determined that tap operation has been performed. As for a Touch Move or sliding operation, the moving direction of the touch position on the touch sensor 102 is also detected. Although the moving direction to be detected is not particularly limited, according to the embodiment, a direction away from the grip portion 101 and approaching the viewfinder 103 (the +X direction or leftward) and a direction away from the viewfinder 103 and approaching to the grip portion 101 (the −X direction or rightward) are detected.

The CPU 201 also performs such control that a function corresponding to operation on the touch sensor 102 is carried out. According to the embodiment, an image to be displayed on the display unit 104 is switched (image feed or image return) in response to sliding operation. In response to a left tap (tap operation on the end portion of the touch sensor 102 on the side of the viewfinder 103 (the +X end portion or the left end portion)), the ISO sensitivity setting is changed to “sunlight”. In response to a right tap (tap operation on the end portion of the touch sensor 102 on the side of the grip portion 101 (the −X end portion, the right end portion, or the end portion opposite to the side of the viewfinder 103), the ISO sensitivity setting is changed to “indoor”. The function to be performed (the function assigned to operation on the touch sensor 102) may be changed, and an imaging parameter other than the ISO sensitivity may be changed.

FIGS. 3A to 3C show how the user operates the touch sensor 102 with the thumb of the right hand which holds the grip portion 101. FIG. 3A shows how the −X end portion (right end portion) of the touch sensor 102 is touched with the thumb 301 (Touch-Down). FIG. 3B shows sliding operation in the +X direction (in the leftward direction) with the thumb 301. FIG. 3C shows how the +X end portion (left end portion) of the touch sensor 102 is touched with the thumb 301 (a Touch-Down). As shown in FIG. 1B, the touch sensor 102 is on the right shoulder of the camera 100. In this way, as shown in FIGS. 3A to 3C, the thumb 301 touches the touch sensor 102 so that the tip thereof points the +X direction.

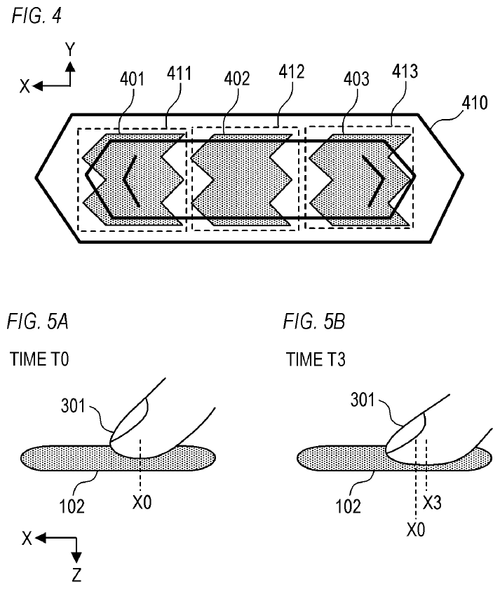

FIG. 4 shows the structure of the touch sensor 102. According to the embodiment, it is assumed that the touch sensor 102 is a capacitive touch sensor. However, another kind of touch sensor may be used, examples of which include a resistive film type sensor, a surface acoustic wave type sensor, an infrared type sensor, an electromagnetic induction type sensor, an image recognition type sensor, and an optical sensor type sensor. The touch sensor 102 includes three touch detection units 401 to 403 (three electrodes). The touch detection units 401 to 403 are covered with a cover 410 and are not exposed. There are regions 411 to 413 corresponding to the touch detection units 401 to 403, respectively, and the output (voltage) across a touch detection unit corresponding to each region varies depending on the size of the touch area (contact area) of the finger in the region. The number of electrodes is not limited to three but may be more or less than three. The shape and arrangement of the electrodes are not particularly limited.

FIGS. 5A and 5B show the movement of the user's thumb 301. The position of the center of gravity or the center position of the part (contact part) of the operation surface of the touch sensor 102 touched by the finger is detected as a touch position. FIG. 5A shows a state at time T0, and a position X0 on the touch sensor 102 is detected as a touch position. FIG. 5B shows at state at time T3 after the time T0 in which the user unconsciously presses the thumb 301 against the touch sensor 102. Therefore, the touch area (the area of the contact part) is increased, the center position or the position of the center of gravity of the contact part changes, and contrary to the user's assumption that the touch position has not changed from the position X0, a position X2 is detected as a touch position. According to the embodiment, the touch position is prevented from being changed against the user's intention and sliding operation from being erroneously detected.

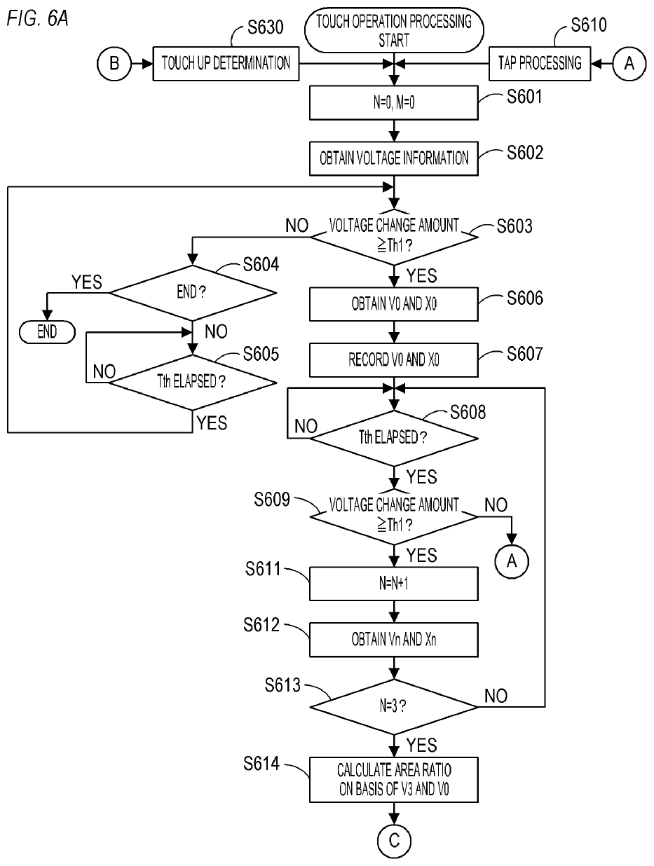

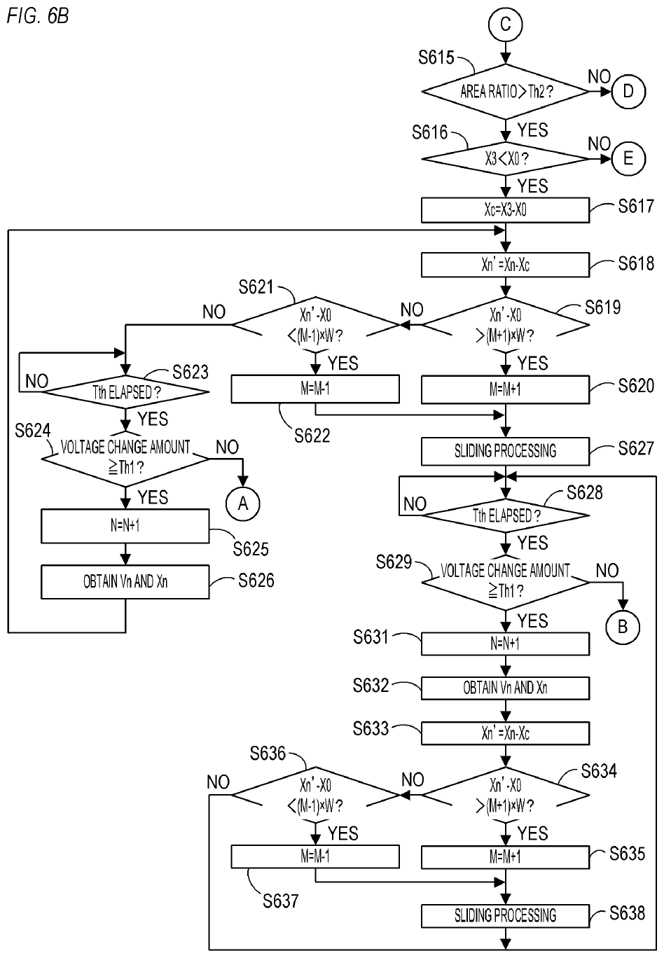

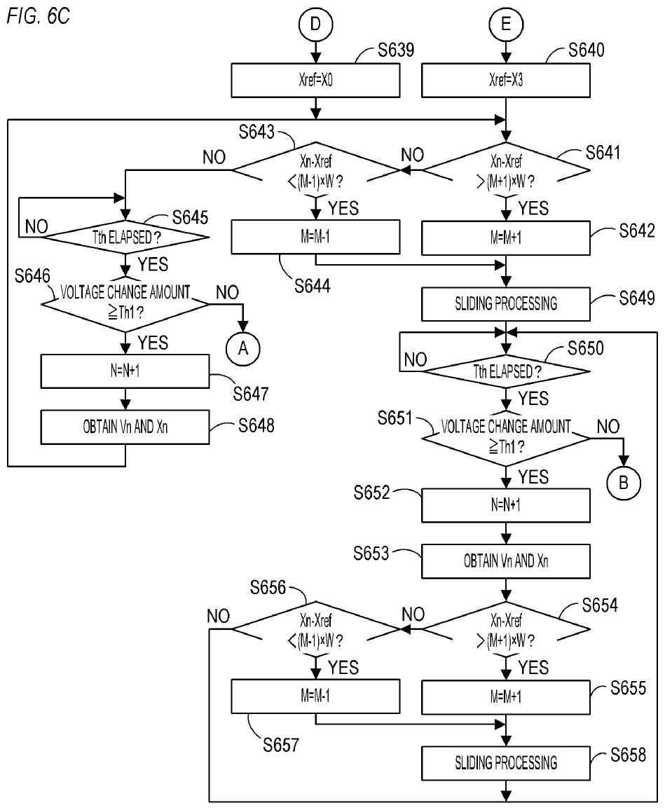

FIGS. 6A to 6C are flowcharts for illustrating details of touch operation processing performed on the camera 100. The processing is implemented as the CPU 201 deploys a program recorded in the non-volatile memory 202 in the memory 203 and executed the program.

In S601 in FIG. 6A, the CPU 201 initializes the variables N and M to 0. The variable N is incremented by one every time it is determined that a touch continues and the variable corresponds to the duration of the touch. The variable M is incremented by one every time sliding operation in the +X direction is detected and decremented by one every time sliding operation in the −X direction is detected and the variable is used to detect the moving direction in the sliding operation.

In S602, the CPU 201 obtains voltage information (voltage) from the touch detection units 401 to 403 of the touch sensor 102.

In S603, the CPU 201 determines, on the basis of the voltage information obtained in S602, whether the voltage change amount (voltage across the touch detection unit−base voltage) is at least equal to the threshold value Th1 in at least one of the touch detection units 401 to 403. When the voltage change is at least equal to the threshold value Th1 in at least one of the touch detection units 401 to 403, the process proceeds to S606; otherwise to S604. When the finger is in contact with the touch sensor 102, the voltage across the touch detection unit at the contact part greatly increases, and it can be determined that the finger touches the touch sensor 102 when there is a touch detection unit having a voltage change amount at least equal to the threshold value Th1. When there is no touch detection unit having at least equal to the threshold value Th1, it can be determined that the finger is not in contact with the touch sensor 102.

In S604, the CPU 201 determines whether the touch operation processing ends. For example, when user operation which instructs the camera 100 to turn off the power supply is performed, the CPU 201 determines that the touch operation processing ends. When it is determined that the touch operation processing ends, the touch operation processing ends; otherwise the process proceeds to S605.

In S605, the CPU 201 stands by until time Tth (time required for charging the touch detection units 401 to 403 (electrodes)) after obtaining the voltage information, and the process proceeds to S602 when the time Tth elapses. As the CPU stands by for the time Tth, the sampling frequency for voltage information is 1/Tth, and the sampling period is Tth. The time Tth is about 5 to 10 msec.

In S606, the CPU 201 obtains voltage information (voltage V0) from the touch detection units 401 to 403 of the touch sensor 102 and obtains (determines) the touch position X0 on the basis of the voltage V0. The voltage V0 is voltage at the start of a touch (a Touch-Down), and the touch position X0 is at the start of a touch. According to the embodiment, values (coordinates) corresponding to 256 steps are obtained as touch positions at the touch sensor 102 (the operation surface) so that the end portion (the +X end portion or the left end portion) on the side of the viewfinder 103 is set to 255 and the end portion (the −X end portion or the right end portion) on the side of the grip portion 101 is set to 0. The number of steps for the touch position may be greater or less than 256.

In S607, the CPU 201 records the touch position X0 and the voltage V0 obtained in S606 in the memory 203.

In S608, the CPU 201 stands by until the time Tth elapses after obtaining the voltage information, and the process proceeds to S609 when the time Tth elapses.

In S609, the CPU 201 determines whether the voltage change amount is at least equal to the threshold value Th1 in at least one of the touch detection units 401 to 403. If the voltage change amount is at least equal to the threshold value Th1 in at least one of the touch detection units 401 to 403, the process proceeds to S611; otherwise to S610.

In S610, the CPU 201 determines that tap operation has been performed and performs tap processing according to the position where the tap operation has been performed. For example, the CPU 201 changes the ISO sensitivity setting to “sunlight” in response to a left tap, and changes the ISO sensitivity setting to “indoor” in response to a right tap.

In S611, the CPU 201 increments the variable N by one because the finger continues to be in contact with the touch sensor 102.

In S612, the CPU 201 obtains voltage information (voltage Vn) from the touch detection units 401 to 403 of the touch sensor 102 and obtains (determines) a touch position Xn on the basis of the voltage Vn. The voltage Vn and the touch position Xn are information obtained when the variable N=n. More specifically, when the variable N=2, voltage V2 and a touch position X2 are obtained.

In S613, the CPU 201 determines whether the variable N has reached a threshold value Nth (the threshold value Nth=3 according to the embodiment). If the variable N=Nth=3, the process proceeds to S614; otherwise to S608. The function corresponding to the movement of the touch position is not executed until the time point at which the variable N=3. The threshold value Nth=3 is determined on the basis of an assumed time period in which the user unconsciously presses his/her finger against the touch sensor 102. When the assumed time period is long, a large value may be used as the threshold value Nth, and when the assumed time period is short, a small value may be used. In consideration of a reference value W for detecting sliding operation, a large value may be used when the reference value W is large, and a small value may be used as the threshold value Nth when the reference value W is small. The threshold value Nth is not particularly limited, and the optimum threshold value Nth varies depending on the structure of the camera 100 and parameters used in the camera 100. Rather than determining whether the variable N has reached the threshold value Nth (determining the duration of the touch), it may be determined whether the voltage Vn has exceeded a threshold value, and the process may proceed to S614 if the voltage Vn has exceeded the threshold value; otherwise to S608.

In S614, the CPU 201 calculates the ratio (area ratio) of the touch area at the time point at which N=0 (at a Touch Down) to the touch area at the time point at which N=3 on the basis of the voltage V3 and the voltage V0. It needs only be determined whether the touch area has increased at an increase rate greater than a predetermined increase rate on the basis of the area ratio (change in touch area in percentage), and it is not necessary to accurately calculate the touch area or the area ratio. After S614, the process proceeds to S615 in FIG. 6B.

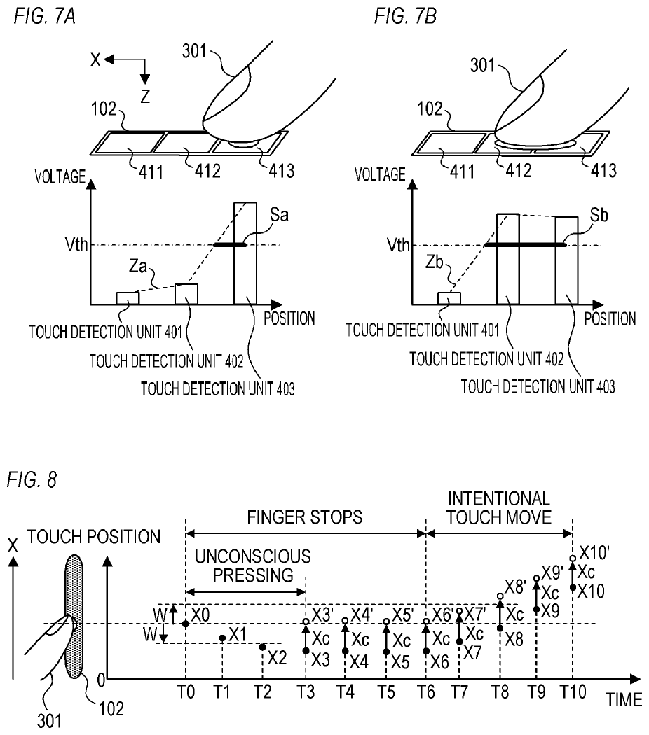

The method for calculating the touch area and the area ratio will be described with reference to FIGS. 7A and 7B. Note that the method for calculating the touch area and the area ratio is not limited to the following method.

FIG. 7A shows a state with a small touch area. In FIG. 7A, the finger is in contact with the region 413 of the touch sensor 102. In this case, the voltage across the touch detection units 401 and 402 decreases, and the voltage across the touch detection unit 403 increases. In a graph where the position of the touch detection unit (the position in the array direction (the left-right direction)) is on the abscissa, and the voltage across the touch detection units is on the ordinate, the CPU 201 calculates, as a touch area, the width Sa of the part where the broken line Za connecting the voltage across the touch detection units 401 to 403 exceeds the threshold value Vth.

FIG. 7B shows a state with a large touch area. In FIG. 7B, the finger is in contact with the regions 412 and 413 of the touch sensor 102. In this case, the voltage across the touch detection unit 401 decreases and the voltage across the touch detection units 402 and 403 increases. In a graph where the position of the touch detection unit (the position in the array direction (the left-right direction)) is on the abscissa and the voltage across the touch detection unit is on the ordinate, the CPU 201 calculates, as a touch area, the width Sb of the part where the broken line Zb connecting the voltage across the touch detection units 401 to 403 exceeds the threshold value Vth.

When the touch area Sa in FIG. 7A is the touch area at the time point at which the variable N=0, and the touch area Sb in FIG. 7B is the touch area at the time point at which the variable N=3, the CPU 201 calculates an area ratio by dividing the touch area Sb by the touch area Sa.

In S615 in FIG. 6B, the CPU 201 determines whether the area ratio calculated in S614 is larger than a threshold value Th2. If the area ratio is greater than the threshold value Th2, the process proceeds to S616; otherwise to S639 in FIG. 6C. Note that the processing may be switched depending on whether the touch area has an increase greater than a predetermined increase from the time point at which variable N=0 to the time point at which variable N=3, and for example, the change amount in the touch area (the touch area Sb−the touch area Sa) may be determined instead of the area ratio (the change rate).

In S616, the CPU 201 determines whether a touch position X3 (coordinate value) is less than the touch position X0 (coordinate value), and determines whether the touch position X3 is in a specific direction or in a different direction from the specific direction as compared to the touch position X0. In other words, the CPU 201 determines whether the touch position X3 is closer to the −X direction (rightwards or a direction approaching the grip portion 101) than the touch position X0 or is in the +X direction (leftwards or a direction away from the grip portion 101). If the touch position X3 (coordinate value) is less than the touch position X0 (coordinate value), the finger touches the surface gradually from the fingertip to the pad of the finger, and the process proceeds to S617. When the touch position X3 (coordinate value) is larger than the touch position X0 (coordinate value), the finger touches the surface gradually from the back of the finger to the fingertip, and the process proceeds to S640 in FIG. 6C. If the touch position X3 (coordinate value) is equal to the touch position X0 (coordinate value), the process may proceed to either S617 or S640, but the process proceeds to S640 according to the embodiment.

In S617, the CPU 201 calculates a correction value Xc by subtracting the touch position X0 (coordinate value) from the touch position X3 (coordinate value).

In S618, the CPU 201 calculates a correction position Xn′ by correcting the current touch position Xn in the direction of the touch position X0, more specifically by subtracting a correction value Xc from the touch position Xn (coordinate value). According to the embodiment, when the area ratio calculated in S614 is larger than the threshold value Th2, the touch position Xn is corrected in the direction of the touch position X0, and this can reduce erroneous detection of sliding operation which may be caused as the user unconsciously pressing the finger against the touch sensor 102. According to the embodiment, when the touch position X3 (coordinate value) is less than the touch position X0 (coordinate value), the touch position Xn is corrected; otherwise the touch position Xn is not corrected. When the touch position X3 (coordinate value) is less than the touch position X0 (coordinate value), the finger touches the surface gradually from the fingertip to the pad, and such a touch tends to occur on the side of the +X end portion. Therefore, when the touch position X3 (coordinate value) is less than the touch position X0 (coordinate value), the touch position Xn is corrected; otherwise the touch position Xn is kept uncorrected, so that the maximum movement width (stroke) of the touch position considered to be effective in sliding operation can be expanded.

In S619, the CPU 201 determines whether the difference (Xn′−X0) between the touch position X0 (coordinate value) and the current corrected position Xn′ (coordinate value) is greater than a threshold value ((M+1)×W). The value W is a reference value for detecting sliding operation. If the difference (Xn′−X0) is greater than the threshold value ((M+1)×W), it is determined that there has been sliding operation in the +X direction and the process proceeds to S620; otherwise the process proceeds to S621.

In S620, the CPU 201 increments the variable M by one.

In S621, the CPU 201 determines whether the difference (Xn′−X0) between the touch position X0 (coordinate value) and the current corrected position Xn′ (coordinate value) is less than a threshold value ((M−1)×W). If the difference (Xe−X0) is less than the threshold value ((M−1)×W), it is determined that there has been sliding operation in the −X direction, and the process proceeds to S622; otherwise the process proceeds to S623.

In S622, the CPU 201 decrements the variable M by one.

According to S619 to S622, when the amount of movement from the touch position X0 to the current corrected position Xn′ (|Xn′−X0| or the difference between the touch positions) is greater than the threshold value, it is determined that sliding operation has been performed and the variable M is updated. Using a value with a sign (Xn′−X0) rather than an absolute value (|Xn′−X0|), the moving direction of sliding operation can be determined.

If no sliding operation is detected at S619 or S621, then in S623, the CPU 201 stands by until the time Tth elapses after obtaining voltage information, and then the process proceeds to S624 when the time Tth elapses.

In S624, the CPU 201 determines whether the voltage change amount is at least equal to the threshold value Th1 in at least one of the touch detection units 401 to 403. If the voltage change is at least equal to the threshold value Th1 in at least one of the touch detection units 401 to 403, the process proceeds to S625; otherwise to S610 in FIG. 6A.

In S625, the CPU 201 increments the variable N by one because the finger continues to be in contact with the touch sensor 102.

In S626, the CPU 201 obtains voltage information (voltage Vn) from the touch detection units 401 to 403 of the touch sensor 102 and obtains (determines) the touch position Xn on the basis of the voltage Vn.

When sliding operation is detected in S619 or S621, the CPU 201 performs sliding processing in S627 according to the moving direction of the performed sliding operation. For example, the CPU 201 performs image reversing to switch images (to be displayed at the display unit 104) so that the images are sequentially displayed in the reverse-chronological order of shooting dates in response to sliding operation in the +X direction and image feeding to switch images so that the images are displayed in the chronological order of shooting dates in response to sliding operation in the −X direction.

In S628, the CPU 201 stands by until the time Tth elapses after obtaining voltage information, and the process proceeds to S629 when the time Tth elapses.

In S629, the CPU 201 determines whether the voltage change amount is at least equal to the threshold value Th1 in at least one of the touch detection units 401 to 403. If the voltage change is at least equal to the threshold value Th1 in at least one of the touch detection units 401 to 403, the process proceeds to S631; otherwise to S630 in FIG. 6A.

In the S630 in FIG. 6A, the CPU 201 determines that there has been a Touch-Up. If the Touch-Up is part of tap operation, tap processing (S10) is performed, while the Touch-Up is here is a Touch-Up after the sliding operation and is not part of the tap operation. According to the embodiment, no function is assigned to the Touch-Up (Touch-Up after sliding operation), and therefore no function is performed even when there has been a Touch-Up. However, the function may be assigned to the Touch-Up (Touch-Up after sliding operation), and the function may be executed in response to the Touch-Up.

In S631 in FIG. 6B, the CPU 201 increments the variable N by one because the finger continues to be in contact with the touch sensor 102.

In S632, the CPU 201 obtains voltage information (voltage Vn) from the touch detection units 401 to 403 of the touch sensor 102 and obtains (determines) the touch position Xn on the basis of the voltage Vn.

In S633, the CPU 201 calculates the corrected position Xn′ by subtracting the correction value Xc from the current touch position Xn (coordinate value).

In S634, the CPU 201 determines whether the difference (Xn′−X0) between the touch position X0 (coordinate value) and the current corrected position Xn′ (coordinate value) is greater than the threshold value ((M+1)×W). If the difference (Xn′−X0) is greater than the threshold value ((M+1)×W), it is determined that there has been sliding operation in the +X direction and the process proceeds to S635; otherwise to S636.

In S635, the CPU 201 increments the variable M by one.

In S636, the CPU 201 determines whether the difference (Xn′−X0) between the touch position X0 (coordinate value) and the current corrected position Xn′ (coordinate value) is less than the threshold value ((M−1)×W). If the difference (Xn′−X0) is less than the threshold value ((M−1)×W), it is determined that there has been sliding operation in the −X direction and the process proceeds to S637; otherwise to S628.

In S637, the CPU 201 decrements the variable M by one.

When the sliding operation is detected in S634 or S636, the CPU 201 performs sliding processing in S638 according to the moving direction of the performed sliding operation.

When the area ratio calculated in S614 (the ratio of the touch area at N=0 to the touch area at N=3) is less than or equal to the threshold value Th2, in S639 in FIG. 6C, the CPU 201 sets the touch position X0 to the reference position Xref, which is the starting point in calculating the movement amount (difference) of the touch position.

When the area ratio calculated in S614 is larger than the threshold value Th2 but the touch position X3 (coordinate value) is equal to or more than the touch position X0 (coordinate value), the CPU 201 sets the touch position X3 to the reference position Xref in S640 in FIG. 6C. Instead of correcting the touch position Xn in the direction of the touch position X0, the touch position X3 may be set to the reference position Xref so that the user can be prevented from accidentally pressing his/her finger against the touch sensor 102 and erroneous detection of sliding operation can be reduced.

In S641, the CPU 201 determines whether the difference (Xn-Xref) between the reference position Xref (coordinate value) and the current touch position Xn (coordinate value) is greater than the threshold value ((M+1)×W). If the difference (Xn-Xref) is greater than the threshold value ((M+1)×W), it is determined that there has been sliding operation in the +X direction and the process proceeds to S642; otherwise to S643.

In S642, the CPU 201 increments the variable M by one.

In S643, the CPU 201 determines whether the difference (Xn-Xref) between the reference position Xref (coordinate value) and the current touch position Xn (coordinate value) is less than the threshold value ((M−1)×W). If the difference (Xn−Xref) is less than the threshold value ((M−1)×W), it is determined that there has been sliding operation in the −X direction and the process proceeds to S644; otherwise to S645.

In S644, the CPU 201 decrements the variable M by one.

If no sliding operation is detected in S641 or S643, then in S645, the CPU 201 stands by until the time Tth elapses after obtaining the voltage information, and then the process proceeds to S646 when the time Tth elapses.

In S646, the CPU 201 determines whether the voltage change amount is at least equal to the threshold value Th1 in at least one of the touch detection units 401 to 403. If the voltage change is at least equal to the threshold value Th1 in at least one of the touch detection units 401 to 403, the process proceeds to S647; otherwise to S610 in FIG. 6A.

In S647, the CPU 201 increments the variable N by one because the finger continues to be in contact with the touch sensor 102.

In S648, the CPU 201 obtains voltage information (voltage Vn) from the touch detection units 401 to 403 of the touch sensor 102 and obtains (determines) the touch position Xn on the basis of the voltage Vn.

When sliding operation is detected in S641 or S643, the CPU 201 performs sliding processing in S649 according to the moving direction of the performed sliding operation.

In S650, the CPU 201 stands by until the time Tth elapses after obtaining the voltage information, and the process proceeds to S651 when the time Tth elapses.

In S651, the CPU 201 determines whether the voltage change amount is at least equal to the threshold value Th1 in at least one of the touch detection units 401 to 403. If the voltage change is at least equal to the threshold value Th1 in at least one of the touch detection units 401 to 403, the process proceeds to S652; otherwise to S630 in FIG. 6A.

In S652, the CPU 201 increments the variable N by one because the finger continues to be in contact with the touch sensor 102.

In S653, the CPU 201 obtains voltage information (voltage Vn) from the touch detection units 401 to 403 of the touch sensor 102 and obtains (determines) the touch position Xn on the basis of the voltage Vn.

In S654, the CPU 201 determines whether the difference (Xn-Xref) between the reference position Xref (coordinate value) and the current touch position Xn (coordinate value) is greater than the threshold value (M+1)×W). If the difference (Xn-Xref) is greater than the threshold value ((M+1)×W), it is determined that there has been sliding operation in the +X direction and the process proceeds to S655; otherwise to S656.

In S655, the CPU 201 increments the variable M by one.

In S656, the CPU 201 determines whether the difference (Xn−Xref) between the reference position Xref (coordinate value) and the current touch position Xn (coordinate value) is less than the threshold value ((M−1)×W). If the difference (Xn−Xref) is less than the threshold value ((M−1)×W), it is determined that there has been sliding operation in the −X direction, and the process proceeds to S657; otherwise to S650.

In S657, the CPU 201 decrements the variable M by one.

When sliding operation is detected in S654 or S656, the CPU 201 performs sliding processing in S658 according to the moving direction of the performed sliding operation.

FIG. 8 is a graph for illustrating an example of change of a touch position over time. The abscissa in the graph in FIG. 8 indicates time and the ordinate indicates the touch position. In FIG. 8, a touch to the touch sensor 102 is initiated at time T0 (a Touch-Down at the touch position X0). Until time T6, the user does not intend to change the touch position, but until time T3, the touch position has changed significantly (the touch positions X0 to X3) contrary to the user's intention as the user unconsciously presses the thumb 301 against the touch sensor 102. The touch area is kept approximately constant from the time T3, and the touch position is held approximately constant from the time T3 to the time T6 (the touch positions X3 to X6). From the time T6, the touch position is changed as intended by the user as the user intentionally moves the thumb 301 (the touch positions X3 to X10).

If the touch position X0 is set to the reference position Xref without applying the present invention, the movement amount (|X2−X0|) of the touch position would exceed the threshold value W at the time T2, and thus sliding operation would be erroneously detected at the time T2. Even if the sliding operation is not detected until the time T3, the sliding operation would be erroneously detected after the time T3.

On the other hand, according to the present invention, since no sliding operation is detected until the time T3, the sliding operation is not erroneously detected at the time T2 (S606 to S613 in FIG. 6A). Then, the touch positions X3 to X10 after the time T3 are corrected in the direction of the touch position X0. More specifically, the correction value Xc=X3−X0 is calculated at the time T3 (S617 in FIG. 6B), and the touch position X3 is corrected to a corrected position X3′=X3−Xc with the correction value Xc (S618 in FIG. 6B). Similarly, the touch positions X4 to X10 at the time T4 to the time T10 are corrected to correction positions X4′ to X10′ with the correction values Xc. This prevents the movement amount of the touch position (|Xn′−X0|) from exceeding the threshold value W until the time T6 since the user does not intend to change the touch position until then, so that erroneous detection of sliding operation can be reduced. As a result, sliding operation as intended by the user can be detected more accurately. In FIG. 8, no sliding operation is detected until the time T7, and since the amount of movement (|X8′−X0|) at the touch position exceeds the threshold value W at the time T8, sliding operation as intended by the user is detected.

First Modification

Hereinafter, a first modification of the embodiment of the present invention will be described. In the touch operation processing shown in FIGS. 6A to 6C, the number of times the sliding processing is performed may be less than the number expected by the user depending on how the user moves his/her finger.

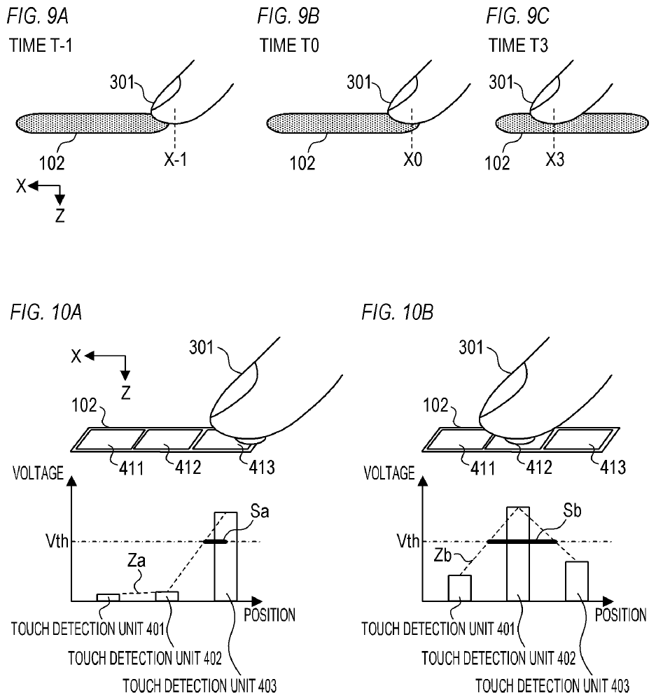

FIGS. 9A and 9B illustrate sliding operation in which the thumb 301 contacts the camera 100 while avoiding touching the touch sensor 102 (regions 411 to 413) and then the thumb 301 enters the region of the touch sensor 102 with extra force. FIG. 9A shows the state of how the thumb 301 contacts the camera 100 while avoiding the touch sensor 102, and the time T−1 and the touch position X−1 are shown for convenience sake. FIG. 9B shows the state of how the thumb 301 is moved from the state in FIG. 9A to the position X0 of the touch sensor 102 at the time T0. FIG. 9C shows the state of how the thumb 301 is moved further from the state in FIG. 9B and the thumb 301 touches the position X3 of the touch sensor 102 at the time T3.

The area ratio (the ratio of the touch area at the time T0 to the touch area at the time T3) during the sliding operation in FIGS. 9A to 9C will be described with reference to FIGS. 10A and 10B. The user does not unconsciously press the thumb 301 against the touch sensor 102.

FIG. 10A shows the state at the time T0. In FIG. 10A, the finger is in contact with the region 413 of the touch sensor 102. In this case, the voltage across the touch detection units 401 and 402 decreases, and the voltage across the touch detection units 403 increases. In the graph in which the position of the touch detection unit (the position in the array direction (the left-right direction)) is indicated on the abscissa, and the voltage across the touch detection units is indicated on the ordinate, the CPU 201 calculates the width Sa of the part of the broken line Za connecting the voltage across the touch detection units 401 to 403 which exceeds the threshold value Vth as a touch area.

FIG. 10B shows the state at the time T3. In FIG. 10B, the finger is in contact with the region 412 of the touch sensor 102. In this case, the voltage across the touch detection units 401 and 403 decreases, and the voltage of the touch detection unit 402 increases. In the graph in which the position of the touch detection unit (the position in the array direction (the left-right direction)) is indicated on the abscissa, and the voltage across the touch detection unit is indicated on the ordinate, the CPU 201 calculates, as a touch area, the width Sb of the part where the broken line Zb connecting the voltage across the touch detection units 401 to 403 exceeds the threshold value Vth.

As shown in FIGS. 10A and 10B, when the sliding operation in FIGS. 9A to 9C is performed, the touch area Sa is extremely small as compared to the touch area Sb even if the user does not unconsciously press the thumb 301 against the touch sensor 102. Therefore, even when the user does not unconsciously press the thumb 301 against the touch sensor 102, the area ratio (Sb/Sa) is large.

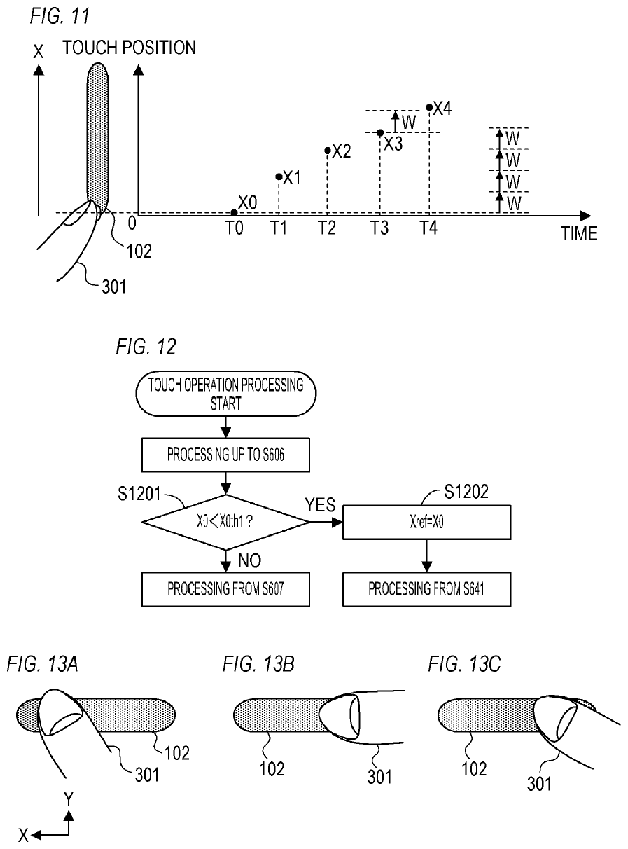

FIG. 11 is a graph showing the change of the touch position over time in the sliding operation in FIGS. 9A to 9C. The user expects the touch position X0 to be the reference position Xref, and all movements up to the touch position X4 result in four sliding operations. However, in the touch operation processing in FIGS. 6A to 6C, detection of sliding operation is not performed until the time T3, so that only one sliding processing (sliding processing at the time of touch position X4) is performed during all the movements up to the touch position X4. Further, when the area ratio (Sb/Sa) shown in FIGS. 10A and 10B is larger than the threshold value Th2, the sliding operation may not be detected at the time T4 since the touch position Xn is corrected or the reference position is set as Xref=X3.

Therefore, an example of sliding processing in response to sliding operation such as the case shown in FIGS. 9A to 9C can preferably be performed (as expected by the user) will be described as the first modification. FIG. 12 is a flowchart for illustrating details of touch operation processing according to the first modification. The processing is implemented as the CPU 201 deploys a program recorded in the non-volatile memory 202 in the memory 203 and executes the program. In the touch operation processing in FIGS. 12, S1201 and S1202 are added to the touch operation processing in FIGS. 6A to 6C.

In S1201 next to S606, the CPU 201 determines whether the touch position X0 at the start of a touch (at a Touch Down) is at the −X end portion (right end portion) of the touch sensor 102, more specifically whether the touch position X0 (coordinate value) is less than a threshold value X0th1. If whether the touch position X0 is at the −X end portion can be determined, the threshold value X0th1 is not particularly limited, but for example, the threshold value X0th1 is a value close to 0. If the touch position X0 (coordinate value) is less than the threshold value X0th1, the process proceeds to S1202; otherwise to S607. In the sliding operation as shown in FIGS. 9A to 9C, the finger often enters the region of the touch sensor 102 from the side of the grip portion 101, so that it is determined in S1201 whether the touch position X0 is at the −X end portion. However, the finger can come into the region of the touch sensor 102 for example from the side of the viewfinder 103, and the end portion to be focused on in S1201 is not particularly limited.

In S1202, the CPU 201 sets the touch position X0 to the reference position Xref.

According to the touch operation processing in FIG. 12, when the touch position X0 is at the end portion (−X end portion) of the touch sensor 102, operation such as standing by until the variable N=3 is established, correction of the touch position Xn, and setting of the reference position Xref to X3 is not performed. Immediately after the touch starts, sliding operation can be detected by setting the reference position Xref to X0. Therefore, when the sliding operation in FIGS. 9A to 9C is performed, sliding processing can be performed four times during all the movements up to the touch position X4 as expected by the user.

Second Modification

Hereinafter, a second modification of the embodiment of the present invention will be described. The first modification focuses on how the user's finger is moved. However, in the touch operation processing in FIGS. 6A to 6C, apart from how the user's finger is moved, the number of times sliding processing is executed is less than the number of times expected by the user at a specific part of the touch sensor 102.

Depending on the position of the touch sensor 102 and its peripheral arrangement, the user may unconsciously press his/her finger against the touch sensor 102 in some parts, and erroneous detection of sliding operation is more likely to happen in the parts, while such accidental pressing is unlikely in other parts. More specifically, if the grip portion 101, the touch sensor 102, and the viewfinder 103 of the camera 100 are in a positional relation as shown in FIG. 1B, erroneous detection of sliding operation is more likely to be caused at the −X end portion (right end portion) of the touch sensor 102. On the other hand, at the +X end portion of the touch sensor 102 (the left end portion or for example, the range from the +X end portion to an approximate center), such erroneous detection of sliding operation is unlikely.

FIGS. 13A to 13C show the thumb 301 in contact with the touch sensor 102. FIG. 13A shows the thumb 301 inclined about 30 degrees relative to the Y direction (the up-down direction) and in contact with the touch sensor 102. FIG. 13B shows the state in which the thumb 301 is substantially parallel to the X-direction (the left-right direction) and is in contact with the touch sensor 102. FIG. 13C shows the thumb 301 inclined about 60 degrees relative to the Y direction and in contact with the touch sensor 102.

Although the degree of inclination of the thumb 301 touching the touch sensor 102 varies among individuals, it is most natural to let the thumb 301 touch the touch sensor 102 as shown in FIG. 13B when the user touches the sensor while grasping the grip portion 101. However, when the touch area easily increases, erroneous detection of sliding operation is easily caused in response to the user's unconscious pressing of the finger against the touch sensor 102. When the thumb 301 is pressed against the +X-end, the user intuitively understands that the touch area easily increases because the thumb 301 covers a large part of the touch sensor 102 in the touching manner as shown in FIGS. 13B and 13C. Therefore, when the thumb 301 is pressed against the +X-end, the user often touches the touch sensor 102 in the touching manner as shown in FIG. 13A which is unlikely to increase the touch area rather than in the touching manner as shown in FIGS. 13B and 13C, so that erroneous detection of sliding operation is less likely to happen. On the other hand, when the thumb 301 is pressed against the −X end portion, the degrees of how easily the touch area increases are equal among the touching manners shown in FIGS. 13A to 13C, the user is not likely to avoid a specific touching manner, so that erroneous detection of sliding operation is easily caused.

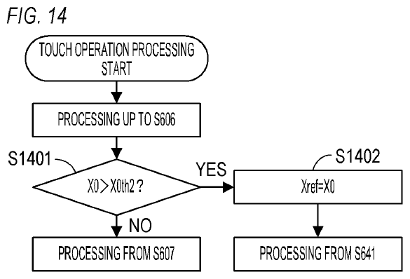

FIG. 14 is a flowchart for illustrating details of touch operation processing according to the second modification. The processing is implemented as the CPU 201 deploys a program recorded in the non-volatile memory 202 in the memory 203 and executes the program. In the touch operation processing in FIGS. 14, S1401 and S1402 are added to the touch operation processing shown in FIGS. 6A to 6C.

In S1401 next to S606, the CPU 201 determines whether the touch position X0 at the start of a touch (a Touch-Down) is at the +X end portion (left end portion) of the touch sensor 102, and whether the touch position X0 (coordinate value) is larger than the threshold value X0th2. In the camera 100, since the viewfinder 103 projects behind the touch sensor 102 (FIG. 1B), it is difficult to move the finger to the +X end portion of the touch sensor 102, and therefore for example an approximate center value of 130 is used as the threshold value X0th2. If whether the touch position X0 is at the +X end portion can be determined, the threshold value X0th2 is not particularly limited, and the threshold value X0th2 may be a value close to 255. If the touch position X0 (coordinate value) is greater than the threshold value X0th2, the process proceeds to S1402; otherwise to S607.

In S1402, the CPU 201 sets the touch position X0 to the reference position Xref.

According to the touch operation processing in FIG. 14, when the touch position X0 is at the end portion (the +X end portion) where erroneous detection of sliding operation is unlikely, operation such as standing by until the variable N=3, correction of the touch position Xn, and setting of the reference position Xref=X3 is not performed. Immediately after the touch starts, sliding operation can be detected by setting the reference position Xref to X0. This allows a function to be performed as expected by the user when touch operation is performed from an end portion which is unlikely to cause erroneous detection of sliding operation.

The above-described various kinds of control by the CPU 201 may be performed by one piece of hardware or multiple pieces of hardware (such as processors and circuits) may play respective roles in processing to control the entire device.

While the present invention has been described in detail with reference to its preferred embodiments, these specific embodiments are not intended to limit the present invention, and various other forms which do not depart from the gist of the present invention also fall within the scope of the present invention. Furthermore, the embodiments described above are each merely indicative of one embodiment of the present invention and arbitrary embodiments may be combined as appropriate.

According to the above-described embodiments, the present invention has been described with reference to an application to an imaging apparatus by way of illustration, but the invention is not limited to the example and is applicable to an electronic device capable of detecting a touch on an operation surface. For example, the present invention is also applicable to a personal computer, a PDA, a mobile phone terminal, a portable image viewer, a printer apparatus, a digital photo frame, a music player, a game machine, an electronic book reader, a video player, a display apparatus (including a projector), a tablet terminal, a smartphone, an AI speaker, a home appliance, and a vehicle on-board apparatus.

According to the present disclosure, user operation intended to move the touch position can be more accurately determined.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-103709, filed on Jun. 3, 2019, which is hereby incorporated by reference herein in its entirety.

What is claimed is:

1. An electronic device comprising:
a touch detector configured to detect a touch on an operation surface; and
at least one memory and at least one processor which function as:
a control unit configured to,
in a first case where a touch is not released and an increase in a touch area from a first time point to a second time point is not more than a predetermined increase, after the second time point,
not control so that a function corresponding to a movement of a touch position is executed when a difference between the touch position at the first time point and a current touch position is less than a threshold value, and
control so that the function corresponding to the movement of the touch position is executed when the difference between the touch position at the first time point and the current touch position is greater than the threshold value, and
in a second case where a touch is not released and the increase in the touch area from the first time point to the second time point is greater than the predetermined increase, after the second time point,
not control so that the function corresponding to the movement of the touch position is executed when the difference between the touch position at the first time point and a corrected position obtained by correcting the current touch position toward the touch position at the first time point is less than the threshold value, and
control so that the function corresponding to the movement of the touch position is executed when the difference between the touch position at the first time point and the corrected position is greater than the threshold value.

2. The electronic device according to claim 1, wherein
in a case where the touch position is at an end portion of the operation surface at the first time point, regardless of whether it is the first case or the second case and whether it is after the second time point, after the first time point, the control unit
does not control so that the function corresponding to the movement of the touch position is executed when the difference between the touch position at the first time point and the current touch position is less than the threshold value, and
controls so that the function corresponding to the movement of the touch position is executed when the difference between the touch position at the first time point and the current touch position is greater than the threshold value.

3. The electronic device according to claim 2, wherein
the operation surface is touchable with a finger of a hand which grasps a grip portion of the electronic device, and
the end portion includes at least one of a first end portion on a side of the grip portion and a second end portion of a side opposite to the first end portion.

4. The electronic device according to claim 1, wherein
in a case which is the second case and where the touch position at the second time point is in a specific direction from the touch position at the first time point, after the second time point, the control unit
does not control so that the function corresponding to the movement of the touch position is executed when the difference between the touch position at the first time point and the corrected position is less than the threshold value, and
controls so that the function corresponding to the movement of the touch position is executed when the difference between the touch position at the first time point and the current touch position is greater than the threshold value, and
in a case which is the second case and where the touch position at the second time point is in a direction different from the specific direction, from the touch position at the first time point, after the second time point, the control unit
does not control so that the function corresponding to the movement of the touch position is executed when the difference between the touch position at the second time point and the current touch position is less than the threshold value, and
controls so that the function corresponding to the movement of the touch position is executed when the difference between the touch position at the second time point and the current touch position is greater than the threshold value.

5. The electronic device according to claim 4, wherein
the operation surface is touchable with a finger of a hand which grasps a grip portion of the electronic device,
the specific direction is a direction approaching the grip portion, and
the direction different from the specific direction is a direction away from the grip portion.

6. The electronic device according to claim 1, wherein
the operation surface is touchable with a finger of a hand which grasps a grip portion of the electronic device, and
the operation surface extends from a side of the grip portion in a direction away from the grip portion.

7. The electronic device according to claim 1, wherein
the control unit does not control so that the function corresponding to the movement of the touch position is executed, until the second time point.

8. The electronic device according to claim 1, wherein
the first case is a case where the touch is not released, and the touch area does not increase at an increase rate greater than a predetermined increase rate from the first time point to the second time point, and
the second case is a case where the touch is not released, and the touch area increases at an increase rate greater than the predetermined increase rate from the first time point to the second time point.

9. The electronic device according to claim 1, wherein
the electronic device is an imaging apparatus.

10. A control method of an electronic device, comprising:
detecting a touch on an operation surface; and
in a first case where a touch is not released and an increase in a touch area from a first time point to a second time point is not more than a predetermined increase, after the second time point,
not controlling so that a function corresponding to a movement of a touch position is executed when a difference between the touch position at the first time point and a current touch position is less than a threshold value, and
controlling so that the function corresponding to the movement of the touch position is executed when the difference between the touch position at the first time point and the current touch position is greater than the threshold value; and
in a second case where a touch is not released and the increase in the touch area from the first time point to the second time point is greater than the predetermined increase, after the second time point,
not controlling so that the function corresponding to the movement of the touch position is executed when the difference between the touch position at the first time point and a corrected position obtained by correcting the current touch position toward the touch position at the first time point is less than the threshold value, and
controlling so that the function corresponding to the movement of the touch position is executed when the difference between the touch position at the first time point and the corrected position is greater than the threshold value.

11. A non-transitory computer readable medium that stores a program, wherein the program causes a computer to execute A control method of an electronic device, the control method comprising:
detecting a touch on an operation surface; and
in a first case where a touch is not released and an increase in a touch area from a first time point to a second time point is not more than a predetermined increase, after the second time point,
not controlling so that a function corresponding to a movement of a touch position is executed when a difference between the touch position at the first time point and a current touch position is less than a threshold value, and
controlling so that the function corresponding to the movement of the touch position is executed when the difference between the touch position at the first time point and the current touch position is greater than the threshold value; and
in a second case where a touch is not released and the increase in the touch area from the first time point to the second time point is greater than the predetermined increase, after the second time point,
not controlling so that the function corresponding to the movement of the touch position is executed when the difference between the touch position at the first time point and a corrected position obtained by correcting the current touch position toward the touch position at the first time point is less than the threshold value, and
controlling so that the function corresponding to the movement of the touch position is executed when the difference between the touch position at the first time point and the corrected position is greater than the threshold value.
